(19) United States
(12) Patent Application Publication
(10) Pub. No.: US 2011/0120795 A1
(43) Pub. Date: May 26, 2011

(54) Protective device for motorcycle fuel tank

(76) Inventors: Jeffrey K. Roby, Marlton, NJ (US); Ryan Rosetti, Marlton, NJ (US)

(21) Appl. No.: 12/592,352

(22) Filed: Nov. 24, 2009

(51) Int. Cl. B62K 11/00

(52) U.S. Cl. 180/219

(57) ABSTRACT

A protective device for a motorcycle fuel tank is an integral unitary component with a lower section and an upper section. The lower section of the component consists of a pliable, hard, yet resilient gel or foam pad or cushion with a curved interior surface configured to be positioned over the rear end of a motorcycle fuel tank. The upper section consists of a flexible top panel. An adhesive is provided on the surface of the bottom of the protective device, which, when placed atop the rear surface of the tank, affixes the protective device on and over the tank. The adhesive immoveably secures the device and serves to maintain it in position. The device serves to protect both the groin of the rider from discomfort and the surface of the tank from damage.

### BACKGROUND OF THE INVENTION

Most common motorcycles are designed with their fuel tanks located on top of or as a part of the upper body of the vehicle, forward of the rider's seat. The configuration requires the cycle rider to operate the vehicle by holding onto the handle bars and to lean forward, over the tank. The rider must therefore compel his body against the rear end of the tank. The result is that riders often experience discomfort while on their cycles, primarily in the groin region, the area of the body which is pushed against the rear end of the tank. Painted surfaces on the rear of the tank itself are also often damaged during vehicle operation by the rider. Objects which are on the person of the rider, e.g. belt buckles, keys, buttons, etc., commonly scratch tank surfaces, as the rider forces his body forward against the tank.

Various motorcycle protective devices have been suggested to address these problems; however, none have been successful in doing so. An example of one such device is found in U.S. Pat. No. 6,663,128, in which a magnetic tank pad is disclosed. This device utilizes lateral flaps which are designed to wrap around the sides of a motorcycle fuel tank and be secured thereto by heavy-duty ceramic magnetics. This device is seriously flawed in that, fundamentally, its size and weight restricts its portability and storage capability. Further, the resulting, need to incorporate a number of separate elements into the device increases its cost of production. Significantly, the use of magnets for attachment makes the tanks susceptible to lateral surface damage from constant removeable and reattachment of the magnets. That magnets are required at all severely restricts the use of the device if magnetic metal surfaces are not readily available. These problems are inherent as well in other protective devices designed to be used on motorcycles.

### SUMMARY OF THE INVENTION

It is thus the object of the present invention to address and overcome the disadvantages and limitations of prior motorcycle fuel tank protective devices.

It is the object of the present invention to provide a protective device for a motorcycle fuel tank which consists of a single, integral unitary body component, consisting of relatively few parts.

It is another object of the present invention to provide a protective device for motorcycle fuel tanks which is easily and readily placed on the rear end of a fuel tank.

It is still another object of the present invention to provide a protective device for a motorcycle fuel tank which, when placed over the tank, is immoveably positioned.

It is a further object of the present invention to provide a protective device for a motorcycle fuel tank which is effective in both protecting the groin of the rider and preventing damage to the fuel tank itself.

It is another object of the present invention to provide a protective device for a motorcycle fuel tank which insures for the comfort of the rider of the motorcycle.

It is another object of the present invention to provide a protective device for a motorcycle fuel tank which is relatively lightweight, portable and easily capable of storage if there is a need to remove it from the motorcycle.

It is another object of the present invention to provide a protective device for a motorcycle fuel tank which is economically manufactured.

These and other objects are accomplished by the present invention, a protective device for a motorcycle fuel tank comprising an integral unitary component with a lower section and an upper section. The lower section of the component consists of a pliable, hard, yet resilient gel or foam pad or cushion with a curved interior surface configured to be positioned over the rear end of a motorcycle fuel tank. The upper section consists of a flexible top panel. An adhesive is provided on the surface of the bottom of the protective device, which when placed atop the rear surface of the tank, affixes the protective device on and over the tank. The adhesive immoveably secures the device and serves to maintain it in position. However, if need dictates, the device can be removed, stored, and then replaced on the tank at a later time by applying additional adhesive on its bottom surface. The device serves to protect both the groin of the rider from discomfort and the surface of the tank from damage.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a view of the protective device in place over the fuel tank of a motorcycle.

FIG. 2 is an isometric view of the top of the protective device of the present invention.

FIG. 3 is an isometric view of the bottom of the protective device of the present invention.

### DETAILED DESCRIPTION OF THE INVENTION

Protective device 1 is a lightweight, integral unit which comprises lower section 2 and upper section 4. Lower section 4 is a pliable hard, yet resilient gel, foam or otherwise cushioned pad having curved, interior surface 6 and exterior surface 8 with indentation 10. Curved, interior surface 6 is configured to be positioned and to fit over curved rear end 26 of motorcycle fuel tank 24 located on motorcycle 20. Indentation 10 is designed to conform with the groin region of a rider positioned on seat 22 of motorcycle 20.

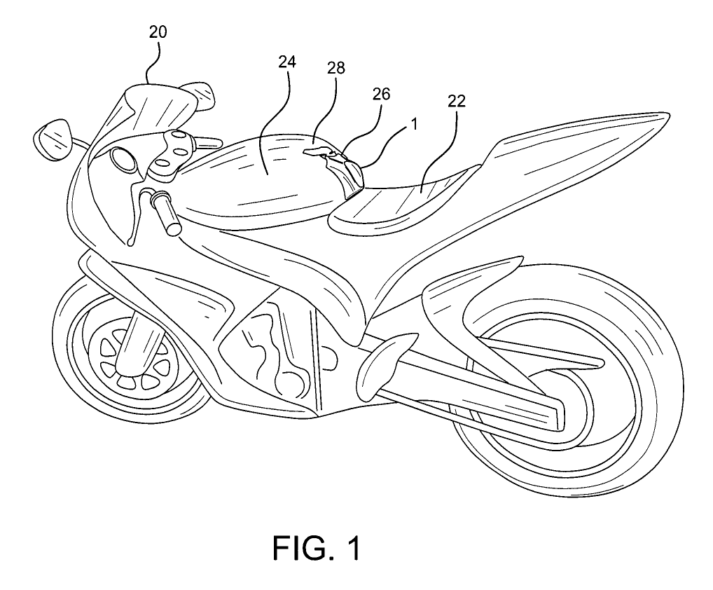

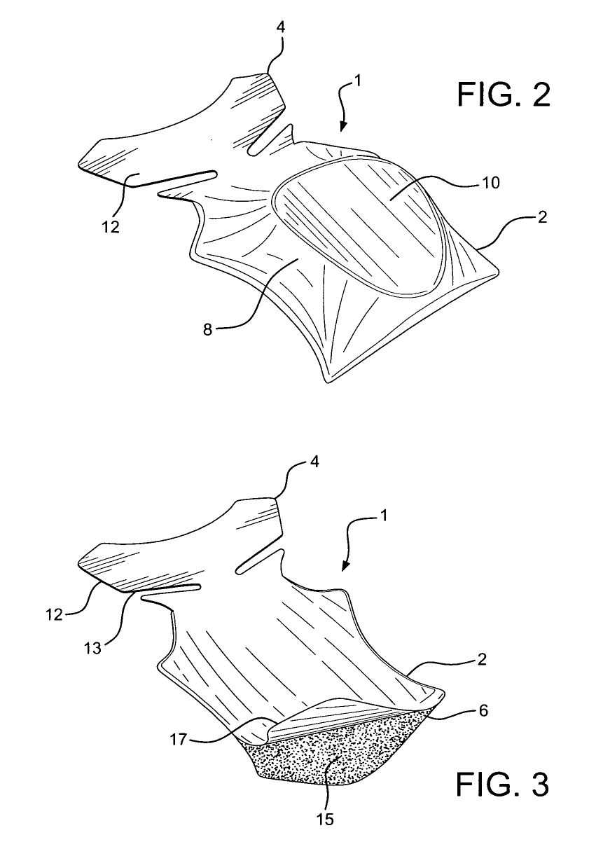

Upper section 4 extends from lower section 2 and comprises flexible top panel 12 with interior surface 13. Panel 12 is of substantially uniform thickness. Adhesive layer 15 is provided on interior surface 6 of lower section 4 and interior surface 13 of panel 12. Protective sheet 17 is provided over adhesive layer 15. When device 1 is to be installed and placed on top rear surface 28 of fuel tank 24, sheet 17 is peeled away so that the device can adhere to the surface of the tank. Thus, when protective device 1 is placed on tank 24, above seat 22, as seen in FIG. 1, the device remains immoveable in this position. No further attachment component is required. When the rider is positioned on seat 22, his groin area not only comfortably rests against protective device 1 positioned on tank 24, but this placement of the protective device will also prevent damage to the outer surface of the tank.

While it is designed to be permanently installed on fuel tank 24, should the need arise to remove protective device 1, it can be lifted off the tank. The lightweight, easily portable nature and size of protective device 1 does make it easy to store. When device 1 is to be reinstalled on tank 24, new adhesive will need to be applied onto interior surfaces 6 and 13.

Critical to the design and function of protective device 1 is the material used for its lower section 2 and upper section 4. Lower section 2, as described previously, must be made of resilient, cushioned, comfortable material. It is anticipated that a memory gel or foam type plastic, similar to computer keyboard wrist rests, or equivalent material, can be used. Upper section 4 is made of a flexible anti-slid, anti-skid material. There are various such materials available, including pliable silicone or polyurethane sheets, rubberized fabric, or equivalent materials, for instance that which is currently utilized in conjunction with hand held PDAs and like devices. This invention is not to be considered restricted to the type of material to be used in the fabrication of lower section 2 or upper section 4.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A protective device for covering the curved rear end and top rear surface of a motorcycle fuel tank, the device being an integral, unitary component comprising:
a lower section having pliable, resilient pad means for shielding the motorcycle fuel tank from damage and protecting the groin of the motorcycle rider, the pad means having a curved, interior surface conforming to the curved rear end of the fuel tank and being configured to be positioned directly over the rear end of the fuel tank, said pad means further having an exterior indentation to conform with the groin of the rider; and
an upper section being integrally connected to the lower section and comprising a flexible top panel means for positioning the protective device immoveably on the fuel tank, the panel means extending upwards from the pad means and having an interior surface which is configured to overlay and conform with the top rear surface of the fuel tank; and
adhesive means overlaying the interior surfaces of the lower and upper sections for securing the protection device to the fuel tank, whereby upon placement of the protective device over the fuel tank, the device is held immoveably in place on the fuel tank solely by the adhesive means on the top rear surface of the fuel tank without any other attachment component.

2. The protective device as in claim 1 wherein the flexible top panel means comprises anti-skid, surface gripping material.

3. The protective device as in claim 1 wherein the flexible top panel means is of substantially uniform thickness.

4. The protective device as in claim 1 wherein the adhesive means comprises an adhesive layer with a removeable protective sheet.
